(19) United States
(12) Patent Application Publication
(10) Pub. No.: US 2012/0222684 A1
(43) Pub. Date: Sep. 6, 2012

(54) INTRAVENOUS THERAPY SITE TAPE AND METHODS OF USING SAME

(76) Inventor: LORI R. BECK, Kirkwood, MO (US)

(21) Appl. No.: 13/405,257

(22) Filed: Feb. 25, 2012

Related U.S. Application Data
(60) Provisional application No. 61/448,040, filed on Mar. 1, 2011.

(51) Int. Cl. A61G 15/00; B65H 3/00; B32B 3/00

(52) U.S. Cl. 128/845; 428/195.1; 221/282

(57) ABSTRACT

An intravenous (IV) site tape secures a portion of a patient to an inflexible object to thereby facilitate secure maintenance in position of an IV line. The IV site tape includes a mid-portion having a first end and an opposed second end, a proximal side and a distal side. A first tape end portion having a proximal side and a distal side, and a second tape end portion having a proximal side and a distal side extend contiguously from the first end and second ends of the mid-portion, respectively. The mid-portion is capable of being placed on a patient so as to pass over the patient's body portion and the first tape end portion and the second tape end portion are capable of being placed at least partially around and removably secured to such inflexible object, to thereby secure such portion of a patient to such inflexible object.

### FIELD OF THE INVENTION

This invention relates, generally, to securement devices used in healthcare applications and, more particularly, to a new medical tape for use in securing a patient's limb or other body portion to an inflexible object for secure maintenance of an intravenous needle or line into the patient.

### BACKGROUND OF THE INVENTION

When intravenous (“IV”) therapy is administered to a patient, conventionally, an arm board is often used to stabilize the insertion site, particularly in pediatric patients, the elderly or other patients who might move around erratically and cause the IV to be compromised. It is to be understood that throughout this document IV will mean either a needle or a cannula, or a combination thereof placed in a patient's blood vessel. Mostly commonly an IV is inserted into a vein in the patient's arm, but it may be at another site, such as the back of a hand, the scalp, a leg, and so on. Accordingly, when the discussion herein is in regard to an “IV site” and or an “arm” it is to be understood that the IV site can be at a number of possible places on the patient. It is further to be understood that the patient can be either human or non-human animal. Once a needle is inserted into a vein, particularly with a young child, an arm board is most commonly used to keep the child's arm still and thereby protect the IV site by securing the board to the site. During the often performed standard IV procedure medical tape is used to secure the arm board to the patient. Ideally, in the conventional procedure, the tape is “double-backed” (using another piece of tape, aligning adhesive with adhesive), so the patient's skin is not unduly irritated by the tape's adhesive portion. This “ideal” prior art taping process is illustrated in FIGS. 1-6, as an example of common practice in stabilizing a patient's arm for insertion of an IV, particularly such a procedure utilizing an arm board.

FIG. 1 illustrates a first step in a conventional IV site preparation procedure, wherein a care-giver pulls two pieces of standard medical tape from a roll, one piece shorter than the other, estimating the length needed for the patient's arm. FIG. 2 illustrates the second step, wherein the care-giver applies the longer length of tape to an available nearby surface, which might or might not be germ-free. Then the shorter length of tape is carefully stuck longitudinally to the longer tape strip, i.e., sticky surface to sticky surface, to create a double-backed length of tape. As shown in FIG. 3, the care-giver then must ensure that the backing tape is thoroughly applied to the longer (main) tape length, before repeating this entire process, steps one through three, as shown respectively in FIGS. 1 through 3, to create at least one more length of double-backed tape.

FIGS. 4-6 illustrate, respectively, the next three steps of the convention procedure discussed above. FIG. 4 shows the care-giver taking the prepared lengths of doubled medical tape in order to be ready to apply the tape lengths to the patient. FIG. 5 shows the patient's arm against an arm board and being strapped to it at one end of the board by use of one of the prepared lengths of doubled tape. FIG. 6 illustrates the application of the second length of doubled standard medical tape to the arm board and the patient's wrist area. During this step, as in Step 5, it is important that the care-giver be careful to align the non-sticky areas of the tape with the patient's skin. Any adhesion of the sticky portion of the tape to skin would necessarily cause the patient discomfort, both during the IV procedure, as well as when the tape is removed from the skin. If the surface to which the tape was first applied in Step 1 (FIG. 1) happened to be contaminated, there would also be the risk of contaminating the patient with the same tape during the IV procedure.

As explained further below and illustrated in FIGS. 1-6, this known and currently used method is complicated, time consuming, and may compromise both patient comfort and the clean environment during the performance of its multiple steps, a minimum of six. It is also particularly cumbersome to perform under stress, in a rush, with a severely injured or moving patient and/or while wearing gloves, as can be required, depending upon a number of medical factors. Due to the time intensive nature of the process, it is often skipped if a facility, such as an Emergency Room, is handling a high volume of patients, or if time is otherwise of the essence. If the current process is skipped, or even performed incompletely or carelessly, it will result in an application of medical tape in which medical tape adhesive is in direct contact with a significant portion of the patient's skin, causing skin irritation and potential epidermal stripping upon removal. Such effects can readily lead to skin tears, infections, lesions or other dermal trauma, adding further to the patient's discomfort.

### SUMMARY OF THE INVENTION

The present invention is a new product for use primarily in maintaining a secure IV site. The invention, although referred to herein for purposes of simplicity as “IV site tape” or simply “IV tape,” may be used for other purposes in which an apparatus, such as a splint, is secured to a patient, or in other instances where there can be bare skin in contact with the adhesive of the hospital tape. Also described and disclosed herein are methods of securing an IV site using IV site tape of the invention.

The invention provides an array of benefits to the patient and the care-giver. For example, the IV site tape of the invention minimizes the surface area of skin that comes in contact with adhesive. While a critical feature of the new IV site tape is that substantially any portion of the tape that is in contact with the patient's skin is adhesive free, that same area of the tape can also include perforations for aeration and/or an absorbent backing, such as cotton (as only one useful example), for patient comfort and to further reduce the risk of compromises to skin integrity and/or infection by reducing moisture on the skin. Because there is little or no contact between the adhesive of the new IV tape and skin, removal of the tape is essentially painless. As noted below, IV site tape of the invention is preferably, although, not necessarily, provided with a line of transverse perforations, a marking or other features to allow tearing, cutting, or otherwise providing the IV site tape in an appropriately sized unit. This feature: (1) allows the caregiver to place the tape directly onto the patient, without time-wasting and awkward adjustment, and (2) minimizes the amount of time that the IV site tape is exposed to an unclean environment prior to placement on the patient. When IV site tape of the invention is used at an IV site, adhesive is preferably not in contact with the patient's skin at all. Therefore, there is little to no pain, discomfort or skin trauma for the patient when the new IV site tape is removed from the IV site. Further, there is little disturbance to the patient when the site is checked, and may allow for checking an IV site with reduced patient anxiety and/or without waking a sleeping patient. When used in connection with securing an IV site, as illustrated below, the number of steps is significantly reduced in comparison to the prior art method and results in increased efficiency, efficacy, and patient comfort.

Thus, in keeping with the above advantages, the invention is, briefly, an intravenous (IV) site tape for securing a portion of a patient to an inflexible object to thereby facilitate secure maintenance in position of an IV line. The IV site tape includes a mid-portion having a first end and an opposed second end, a proximal side and a distal side. A first tape end portion having a proximal side and a distal side, and a second tape end portion having a proximal side and a distal side extend contiguously from the first end and second ends of the mid-portion, respectively. The mid-portion is capable of being placed on a patient so as to pass over the patient's body portion and the first tape end portion and the second tape end portion are capable of being placed at least partially around and removably secured to such inflexible object, to thereby secure such portion of a patient to such inflexible object.

The invention is also, briefly, a method of securing an IV therapy site, the method comprising the steps of: a) providing IV site tape to thereby facilitate secure maintenance in position of an IV site, the IV site tape having: a mid-portion having a first end and an opposed second end, a proximal side and a distal side; a first tape end portion having a proximal side and a distal side, and a second tape end portion having a proximal side and a distal side, the first tape end portion extending contiguously from the first end of the mid-portion and the second tape end portion extending contiguously from the second end of the mid-portion, wherein the mid-portion is capable of being placed on a patient so as to pass over at least one side of the patient's body portion and further wherein the first tape end portion and the second tape end portion are capable of being placed at least partially around and removably secured to such inflexible object, to thereby secure such body portion of a patient to such inflexible object; b) wrapping a segment of the IV site tape around the patient's body portion at one location on the body portion and then securing the IV site tape to the inflexible object; c) wrapping another segment of the IV site tape around the patient's body portion at another location on the body portion, and then d) securing the other segment of IV site tape to the inflexible object, to thereby quickly and removably secure an IV site on the patient's body portion for the duration of an IV procedure.

### BRIEF DESCRIPTION OF THE DRAWINGS

The present invention may be better understood and its numerous objects, features and advantages made apparent to those skilled in the art by referencing the accompanying drawings. Throughout the drawings like elements are represented by like numerals.

FIG. 1 is a schematic view of a roll of conventional surgical tape being opened and a length of rape being prepared by a user/care-giver in a first step of a known method of securing an arm board to a patient's arm as preparation of an IV site. Also during this step a second length of tape is also separated from the roll, one length being shorter than the other, the user estimating the lengths needed for the specific patients' arm size.

FIG. 2 is a schematic view of next step of the conventional method of securing an IV site, as initiated in FIG. 1. A longer length of medical tape is applied to any nearby available surface, which might not be clean, and then a shorter section of medical tape is turned over and fastened to the approximate center of the longer section of tape, sticky side to sticky side, to create a double-backed strip of tape.

FIG. 3 is a schematic view of a further step of the conventional method of FIG. 1. In this step the backing tape is rechecked and thoroughly applied to the main strip of tape.

FIG. 4 is a schematic view of a next step of the conventional method of FIG. 1, wherein the steps of FIGS. 1-3 have all been repeated to prepare another double-backed tape strap, similar to the first, ready for use.

FIG. 5 is a schematic view of a step of the method started in FIG. 1, wrapping a first strap around an arm board and a patient's arm, near the elbow, with one of the strips of double-backed tape previously prepared.

FIG. 6 is a schematic view of a final step of the conventional method of FIG. 1 of securing an arm board to a patient's arm near or at the wrist with the other strip of prepared double-backed tape.

FIG. 7 is a schematic view of a roll of the new IV site tape being unrolled.

FIG. 8 is a schematic view of the new IV site tape of FIG. 8 being applied to secure a patient's arm to an arm board.

FIG. 9A is a schematic illustration of the new IV site tape of FIG. 8 showing dimensions for a size of such tape suitable for use on an infant of up to approximately one year of age.

FIG. 9B is a schematic illustration of the new IV site tape of FIG. 8 showing dimensions on the proximal surface for a size of such tape suitable for use on an infant of up to approximately one year of age.

FIG. 10A is a schematic illustration of the new IV site tape of FIG. 8 showing dimensions on the distal surface for a size of such tape suitable for use on a toddler of approximately one year to approximately 15 months of age.

FIG. 10B is a schematic illustration of the new IV site tape of FIG. 8 showing dimensions on the proximal surface for a size of such tape suitable for use on a toddler of approximately one year to approximately 15 months of age.

### DETAILED DESCRIPTION OF THE INVENTION

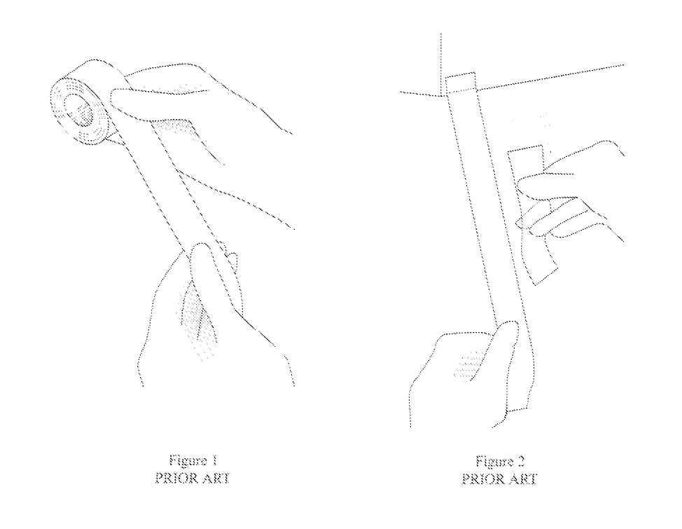

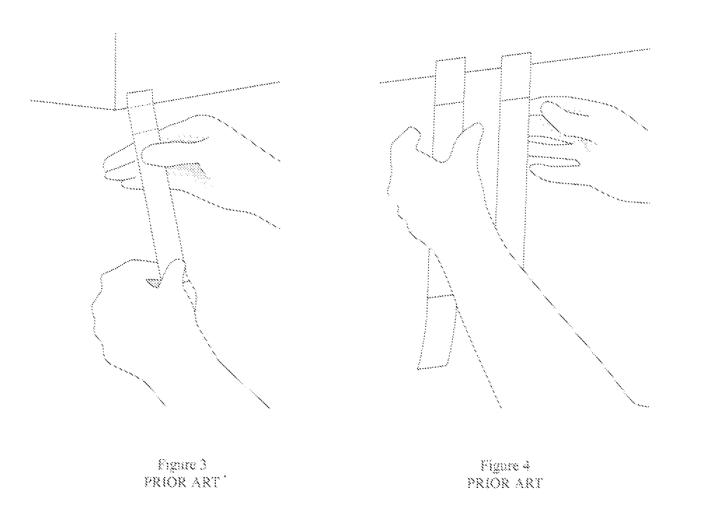

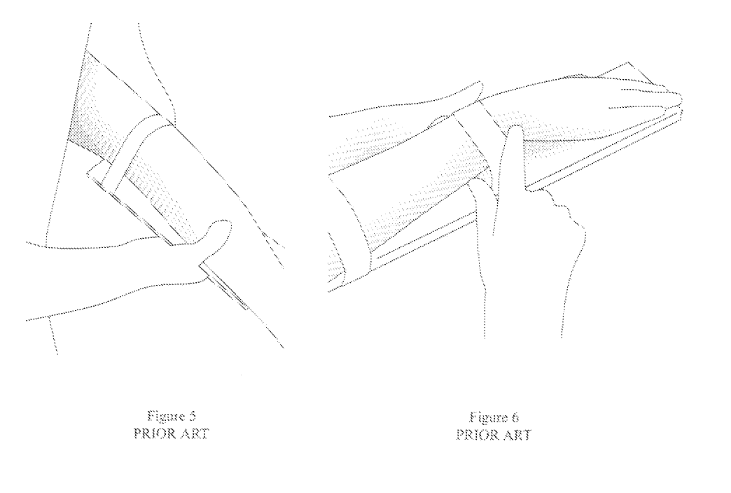

With reference to the drawings, FIGS. 1-6, as explained above, illustrate a known method of securing an arm board for an IV site to a patient, as described in the Background section of this document, above. The remaining FIGS. 7-10, illustrate the various structural elements of the present invention, as described hereafter.

Referring now to FIG. 7, numeral 10 generally designates the new IV site tape of the present invention, in this instance shown on a roll 12 of such tape. When not in a roll, tape 10 is elongated and has a distal surface 14 and an opposed proximal surface 16. Proximal surface 16 is disposed facing the patient's skin during normal use of tape 10 and distal surface 14 faces away from the patient's skin during use. Surfaces 14, 16 are bounded by substantially parallel longitudinal edges 18, 20. The body of tape 10 between edges 18, 20 is preferably, although not necessarily, ventilated across at least a portion thereof from one of surfaces 14, 16 entirely through to the other of such surfaces with myriad tiny apertures, perforations or through-holes, as indicated at 28, so that tape 10 is air permeable and thus more comfortable for the patient by permitting aeration to the patient's skin. If desirable, for manufacturing purposes, providing such through-holes over the entire length of tape 10, rather than just certain portions thereof, would yield an acceptable and useful embodiment of the invention.

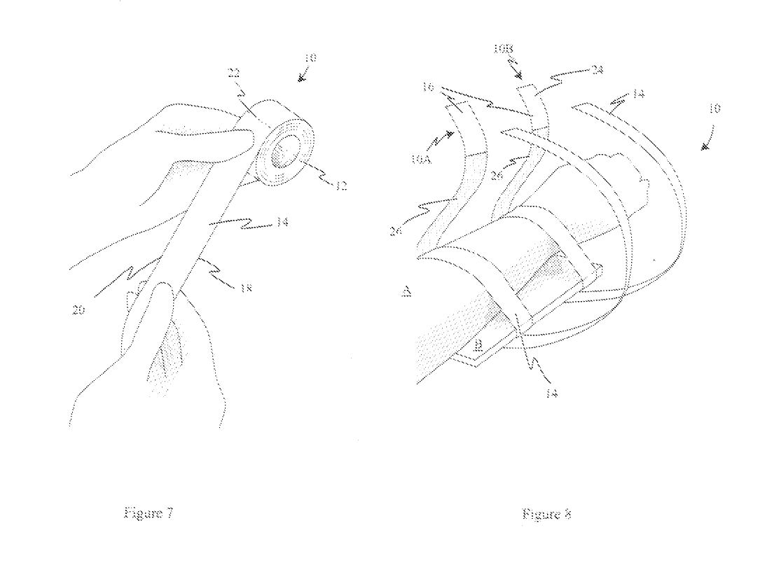

FIG. 8 illustrates segments 10A, 10B of tape 10, which have been separated from roll 12 at preselected distances in order to provide segments of tape 10 of sufficient length to permit temporary binding of a patient's arm A to an arm board B. Spaced apart lines of weakness or perforated lines 22 are preferably provided on distal surface 14 at preselected distances, transversely to the length of tape 10, for facile separation of a length of tape 10 from roll 12. While the place to tear or cut a length of tape 10 from roll 12 can be estimated, the provision of such a line of weakness, or at least an edge notch or marking of some type at the site for tearing/cutting the segment from roll 12 is preferred for accuracy and to reduce waste of the tape and critical time due to errors in estimation.

As an alternative, indicators, such as a transverse line of ink, for example, can be used to designate preferred cutting or tearing locations along a roll of IV site tape. Each segment of IV site tape (wherein each segment is defined on one end by a line of weakness, perforation or other indicator and on the other by the end of the tape or a similar perforation or other indicator) includes a mid-portion 26 which is preferably over-layered with cotton or other absorbent material (such as a highly absorbent synthetic substance) that, when used to secure a patient's IV site, will be in contact with patient's skin. Mid-portion 26 can be acceptably functional without such an absorbent over-layer, although it might be somewhat less comfortable. Mid-portion 26 is flanked on each of its opposed ends with a end portions 24, one on each end of the mid-portion, and having on the proximal side 16 of such end portions 24 a suitable adhesive for use in medical tape. The adhesive bearing end portions 24 sized on a segment of tape 10 such that in normal use position the adhesive portions 24 will come in contact only with the inflexible object to which the patient's limb or other body portion is secured for the purpose of IV therapy. Thus, the mid-portion 26, with or without an absorbent over-layer, and with or without aeration holes, will contact the patient's skin and may potentially come in contact also with the arm board B or other inflexible supporting object, but adhesive portions 24 are to be disposed only against a non-skin surface in or around the IV site in normal use position.

As a further alternative, instead of being provided on a roll 12, a plurality of the segments described above, such as 10A, 10B, can be precut and packaged in lots of a given number of segments, such as, for example, twenty Iv tape segments of a given size per pack or dispenser. The IV site tape segments in such a package can be arranged, and the package designed, such that one segment can be readily and quickly removed at a time, without contaminating the other packaged segments. A suitable package for this alternative may already exist, and other suitable packages for the IV tape of the present invention may still be developed which would be useful with the invention.

Preferably, IV site tape is provided in different “sizes”, e.g., one size adapted to fit most infants, another size adapted to fit most toddlers and/or adolescents, and one or more sizes adapted to fit adults, varied according to patient size. Furthermore, sizing may differ depending upon the likely site of usage. When used to secure an IV site, IV tape 10 will be used most commonly on a patient's lower arm or hand. However, in other embodiments, the new IV site tape may be used in connection with securing an IV site and/or other device to another body portion, e.g., a foot or lower leg, or even possibly the patient's scalp. Further, IV site tape 10 can be used in veterinary applications, in which case overall sizing and relative proportions of the entire length and wide of a single tape 10 segment, compared to the mid-portion 26 may be based, at least in part, upon animal type, age, weight, and the like.

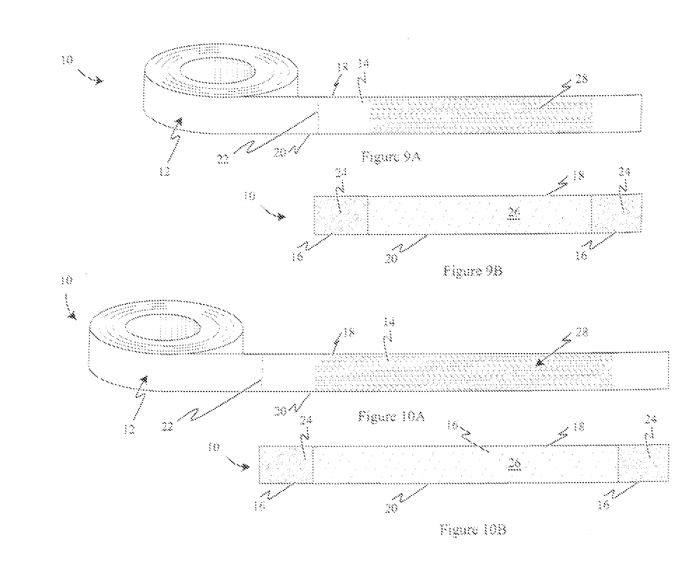

Illustrated in the FIGS. 9A, 9B, 10A, 10B are two useful embodiments of IV site tape of the invention. FIGS. 9A, 9B indicated useful dimensions for use of IV tape 10 on an infant of up to about 12 months of age. In this case the overall length of a segment 10A is about eight inches and the mid-portion is approximately five inches. In FIGS. 10A, 10B the dimensions indicated are preferred for a toddler of from about one to about five years of age. In this case the length of tape segment 10A is about 10.5 inches and the mid-portion is approximately 5.5 inches long. In each set of figures the width of tape 10 is shown as being one inch, a common size for hospital tape. While the noted dimensions are presently preferred for use in connection with the noted ages, other tape widths and lengths may be used and, as noted above, other dimensions (both of segments and of adhesive portions 24 and non-adhesive mid-portions 26) may be successfully used in other embodiments. For example, with some patients and some IV sites new tape 10 could be useful at only ¾ inches wide, and in some cases a tape width of two inches might be useful. The key is that the overall length of the tape segment must be sufficient to permit wrapping of the tape around a patient's body portion which will have an IV site, and include enough length to also permit simultaneously wrapping around an arm board, bed rail or other suitable rigid or inflexible stabilization device for the particular body portion bearing the IV site to be sufficiently immobilized to protect the integrity of the IV site. Simultaneous to the above requirement, the new IV tape must also include a mid-portion 26 which is non-adhesive, and preferably absorbent, on the proximal facing side 16 of the tape, which non-adhesive portion is sized appropriately to provide all the tape contact area for the patient's skin during immobilization of the patient's body portion during an IV procedure.

In the various embodiments of the invention, different sizes can be provided in different colors, for example, to allow easy identification of the appropriate size. Other markers or indicators may also or alternatively be used to indicate size differences among a set of IV site tapes. Of course various other designs may be added to the tape, for example, an animal print to amuse and entertain children, or simply an area to write on identification and/or information purposes.

Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

I claim:

1. Intravenous (IV) site tape for securing a body portion of a patient to an inflexible object, to thereby facilitate secure maintenance in position of an IV line, the IV site tape comprising:
a mid-portion having a first end and an opposed second end, a proximal side and a distal side;
a first tape end portion having a proximal side and a distal side, and
a second tape end portion having a proximal side and a distal side, the first tape end portion extending contiguously from the first end of the mid-portion and the second tape end portion extending contiguously from the second end of the mid-portion,
wherein the mid-portion is capable of being placed on a patient so as to pass over at least one side of the patient's body portion and further wherein the first tape end portion and the second tape end portion are capable of being placed at least partially around and removably secured to such inflexible object, to thereby secure such body portion of a patient to such inflexible object.

2. The IV site tape of claim 1, wherein the proximal side of the mid-portion is layered with an absorbent substance to provide patient comfort by reducing friction and moisture-causing irritation of the patient's skin during an IV procedure and during removal of the IV site tape from the patient.

3. The IV site tape of claim 2, wherein the absorbent substance is formed at least in part of cotton.

4. The IV site tape of claim 2, wherein the absorbent substance is formed at least in part of an artificial substance.

5. The IV site tape of claim 1, wherein at least the mid-portion has a plurality of through-holes to provide aeration to the patient's skin.

6. The IV site tape of claim 1, wherein the proximal side of the first tape end portion and the proximal side of the second tape end portion are provided with an adhesive to thereby removably secure the first tape end portion and the second tape end portion to such inflexible object.

7. The IV site tape of claim 1, wherein the tape is provided in a roll of a plurality of segments connected lengthwise to one another, each segment having a mark at its opposed ends, between adjacent segments, wherein each segment consists of a mid-portion and a first tape end portion and a second tape end portion.

8. The IV site tape of claim 7, wherein the mark between each adjacent segment of IV site tape is a line of weakness to facilitate accurate removal of a single segment from the roll at one time.

9. The IV site tape of claim 1, wherein the mid-portion is approximately five inches long and each of the first tape end portion and the second tape end portion is approximately two inches long, for use on an infant patient of up to about one year of age.

10. The IV site tape of claim 1, wherein the mid-portion is approximately 5.5 inches long and each of the tape first end portion and the tape second end portion is approximately 2.5 inches long, for use on a toddler patient of from about 1 year of age to about five years of age.

11. An IV site tape kit comprising:
a plurality of IV site tape segments, wherein each IV site tape segment consists of:
a mid-portion having a first end and an opposed second end, a proximal side and a distal side;
a first tape end portion having a proximal side and a distal side, and
a second tape end portion having a proximal side and a distal side, the first tape end portion extending contiguously from the first end of the mid-portion and the second tape end portion extending contiguously from the second end of the mid-portion,
wherein the mid-portion is capable of being placed on a patient so as to pass over at least one side of the patient's body portion and further wherein the first tape end portion and the second rape end portion are capable of being placed at least partially around and removably secured to such inflexible object, to thereby secure such body portion of a patient to such inflexible object; and
a dispenser of suitable size and shape to hold a predetermined number of the plurality of the IV site tape segments and to permit facile removal of a single IV site tape segment from the dispenser at one time without soiling any contents of the dispenser and also without soiling the IV site tape segment removed from the dispenser before the IV site tape segment removed is placed in a removably secure position on the patient and the inflexible object.

12. A kit for securing an IV site comprising:
intravenous (IV) site tape for securing a body portion of a patient to an inflexible object, to thereby facilitate secure maintenance in position of an IV line, the IV site tape comprising:
a mid-portion having a first end and an opposed second end, a proximal side and a distal side;
a first tape end portion having a proximal side and a distal side, and
a second tape end portion having a proximal side and a distal side, the first tape end portion extending contiguously from the first end of the mid-portion and the second tape end portion extending contiguously from the second end of the mid-portion,
wherein the mid-portion is capable of being placed on a patient so as to pass over at least one side of the patient's body portion and further wherein the first tape end portion and the second tape end portion are capable of being placed at least partially around and removably secured to such inflexible object, to thereby secure such body portion of a patient to such inflexible object; and
an inflexible object to which to attach a patient's body portion by use of the IV site tape.

13. The kit of claim 12, wherein the inflexible object is an arm board.

14. A method of securing an IV site, the method comprising the steps of:
a) providing IV site tape to thereby facilitate secure maintenance in position of an IV site, the IV site tape having:
a mid-portion having a first end and an opposed second end, a proximal side and a distal side;
a first tape end portion having a proximal side and a distal side, and
a second tape end portion having a proximal side and a distal side, the first tape end portion extending contiguously from the first end of the mid-portion and the second tape end portion extending contiguously from the second end of the mid-portion,
wherein the mid-portion is capable of being placed on a patient so as to pass over at least one side of the patient's body portion and further wherein the first tape end portion and the second rape end portion are capable of being placed at least partially around and removably secured to such inflexible object, to thereby secure such body portion of a patient to such inflexible object;
b) wrapping a segment of the IV site tape around the patient's body portion at one location on the body portion and then securing the IV site tape to the inflexible object;
c) wrapping another segment of the IV site tape around the patient's body portion at another location on the body portion, and then
d) securing the other segment of IV site tape to the inflexible object, to thereby quickly and removably secure an IV site on the patient's body portion for the duration of an IV procedure.
